(19) United States
(12) Patent Application Publication
(10) Pub. No.: US 2026/0200811 A1
(43) Pub. Date: Jul. 16, 2026

(54) EXTERNAL PART COMPRISING A STACK OF INTERFERENCE LAYERS DEPOSITED ON A FACE MADE OF CHROMIUM CARBIDE

(71) Applicant: The Swatch Group Research and Development Ltd, Marin (CH)

(72) Inventors: Camille HALLER, Yverdon-les-Bains (CH); Loïc CURCHOD, Lausanne (CH); Marie BAUDOZ, Morteau (FR); Giovanni POLY, Maiche (FR)

(73) Assignee: The Swatch Group Research and Development Ltd, Marin (CH)

(21) Appl. No.: 19/386,712

(22) Filed: Nov. 12, 2025

(30) Foreign Application Priority Data
Dec. 20, 2024 (EP) 24222435.0

(51) Int. Cl. C04B 41/87; C04B 41/00; C04B 41/45; C04B 41/52

(52) U.S. Cl. CPC C04B 41/87; C04B 41/009; C04B 41/4529; C04B 41/52

(57) ABSTRACT

An external part (10) including a substrate (100) having a support face (101) made of chromium carbide CrₓC_{y} in which the complex refractive index at a wavelength of 550 nm has a real part n>1 and an imaginary part k<1.5, on which is deposited a thin-film dielectric coating (110) formed by at least one alternation of layers made of TiO₂ and Al₂O₃ and comprising a terminal layer (111) made of TiO₂ and a base layer (112) overlying the support face (101) made of TiO₂ or of Al₂O₃.

### CROSS REFERENCE TO RELATED APPLICATION

This application claims priority to European Patent Application No. 24222435.0 filed Dec. 20, 2024, the entire contents of which are incorporated herein by reference.

### TECHNICAL FIELD OF THE INVENTION

The invention relates to the field of horology, jewellery or fine jewellery, and more specifically to an external part for use in horology, jewellery or fine jewellery.

In this specification, the term “external part” refers, as is commonly understood in the aforementioned fields, to a component that is visible to a user and has a decorative function, meaning that it contributes to the visual appearance of an object.

### TECHNOLOGICAL BACKGROUND

In the fields of horology, jewellery and fine jewellery, aesthetics is generally a major objective.

In the horology field, for example, external parts, such as dials, enable a horology brand to stand out from its competitors, and help shape the identity of a brand or of a watch model.

To colour an external part, a plating is commonly deposited on a substrate, generally made of a metallic material, for example by painting, varnishing or enamelling. However, these colouring methods are not always suitable insofar as the layer of material applied to the surface of the substrate is too thick to reveal any surface structuring, for example a brushed, sunray, sandblasted or laser-structured surface, etc., and on the other hand, the lifespan of this layer and consequently of its colour is not always satisfactory.

Thin-film vacuum deposition techniques are therefore preferred, such as physical vapour deposition (known by its acronym “PVD”), chemical vapour deposition (known by its acronym “CVD”) and atomic layer deposition (known by its acronym “ALD”) methods. These thin-film vacuum deposition techniques make it possible to deposit thin, resistant layers, typically suitable for plating small parts comprising, for example, fine surface structuring.

Nevertheless, these deposition techniques make it possible to give an external part a limited number of colours.

The present invention aims to obtain an external part with a new range of colours that preserves the appearance of any substrate structuring.

### SUMMARY OF THE INVENTION

The invention remedies the aforementioned drawbacks and relates, to this end, to an external part for horology, jewellery or fine jewellery, comprising a substrate having a support face made of chromium carbide CrₓC_{y} in which the complex refractive index at a wavelength of 550 nm has a real part n>1 and an imaginary part k<1.5, on which is deposited a semi-transparent thin-film dielectric coating formed by at least one alternation of layers made of TiO₂ and Al₂O₃ and comprising a terminal layer made of TiO₂ and a base layer made of TiO₂ or of Al₂O₃ overlying the support face.

The invention advantageously makes it possible to impart a new colour to the external part, while providing chemical and environmental protection. Advantageously, the colour imparted to the external part depends on the stoichiometric ratio between carbon and chromium on the support face.

In particular embodiments, the invention can further comprise one or more of the following features, taken separately or in any technically possible combination.

In some particular embodiments, the support face is a face of a support layer made of CrₓC_{y}.

In some particular embodiments, the support face has an equal atomic proportion of carbon and of chromium.

In some particular embodiments, the thin-film dielectric coating comprises five layers, the base layer being made of TiO₂, the layers in the thin-film dielectric coatings having thicknesses chosen so as to impart an interference colour to the external part characterised, in the CIELAB space in the reflection mode of the standardised illuminant D65, with an observer of 10° and a measurement geometry di:8°, by the parameters L*=[45; 55], a*=[−10; 0], b*=[0; 10].

In some particular embodiments, the thin-film dielectric coating comprises six layers, the base layer being made of Al₂O₃, the layers in the thin-film dielectric coatings having thicknesses chosen so as to impart an interference colour to the external part characterised, in the CIELAB space in the reflection mode of the standardised illuminant D65, with an observer of 10° and a measurement geometry di:8°, by the parameters L*=[15; 25], a*=[35; 45], b*=[15; 25].

In some particular embodiments, the support face has a lower atomic proportion of chromium than of carbon.

In some particular embodiments, the support face has an atomic percentage of carbon greater than 60%.

In some particular embodiments, the thin-film dielectric coating comprises three layers, the base layer being made of TiO₂, the layers in the thin-film dielectric coatings having thicknesses chosen so as to impart an interference colour to the external part characterised, in the CIELAB space in the reflection mode of the standardised illuminant D65, with an observer of 10° and a measurement geometry di:8°, by the parameters L*=[70; 80], a*=[−10; 0], b*=[−5; 5].

In some particular embodiments, the support face has an atomic percentage of carbon greater than 80%.

In some particular embodiments, the thin-film dielectric coating comprises six layers, the base layer being made of Al₂O₃, the layers in the thin-film dielectric coatings (110) having thicknesses chosen so as to impart an interference colour to the external part (10) characterised, in the CIELAB space in the reflection mode of the standardised illuminant D65, with an observer of 10° and a measurement geometry di:8°, by the parameters L*=[35; 45], a*=[−5; 5], b*=[−10; −20].

### BRIEF DESCRIPTION OF THE FIGURES

Other features and advantages of the invention will become apparent from the following detailed description, given by way of non-limiting example, with reference to the figures in which:

FIGS. 1 and 2 show a schematic cross-sectional view of an external part according to a first and a second variant, respectively, of a first exemplary embodiment of the present invention,

FIGS. 3 and 4 show a schematic cross-sectional view of an external part according to a first and a second variant, respectively, of a second exemplary embodiment of the present invention.

It should be noted that the figures are not drawn to scale for clarity reasons.

### DETAILED DESCRIPTION OF THE INVENTION

The present invention relates to an external part 10 used in horology, jewellery or fine jewellery, comprising a substrate 100 having a support face 101 made of chromium carbide CrₓC_{y}.

In particular, the substrate 100 can be formed by a body on which a layer made of CrₓC_{y} is deposited, for example by physical vapour deposition, known to persons skilled in the art by the acronym “PVD.” The support face 101 is then formed by the chromium carbide layer thus deposited. Such a layer can have a thickness comprised between 50 nm and 10 μm, and preferentially between 50 nm and 500 nm.

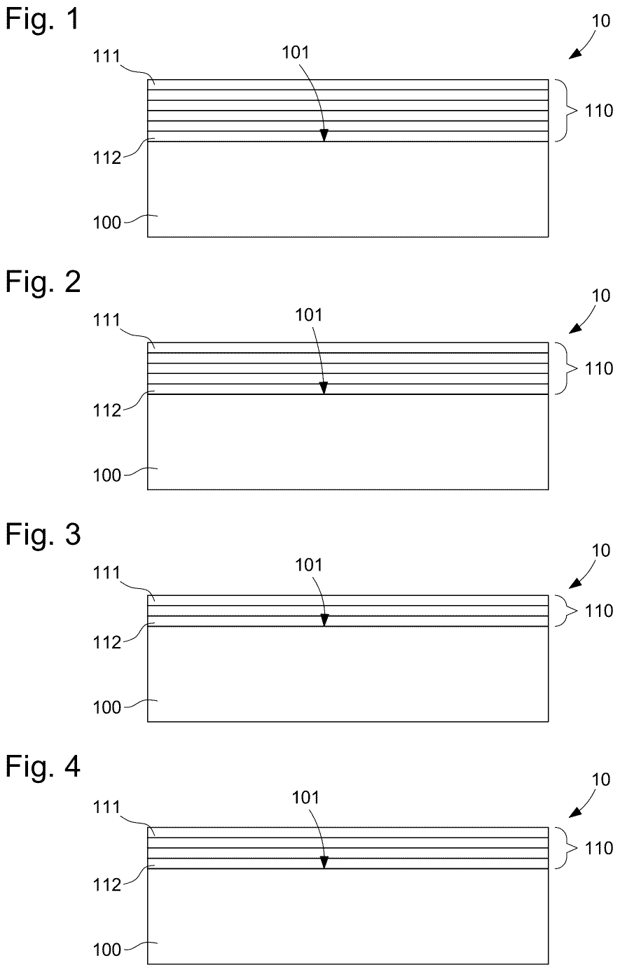

The external part 10 according to the invention is schematically shown in FIGS. 1 and 2 and is particularly suitable for forming a dial for a timepiece, or any other preferentially internal part of the timepiece.

The external part 10 comprises, on its support face 101, a thin-film dielectric coating 110 that is semi-transparent, that is, at least transparent in the visible field. The layers in the thin-film dielectric coatings (110) are deposited by a method known to persons skilled in the art by the acronym “ALD,” for “Atomic Layer Deposition.” Each layer in the thin-film dielectric coating 110 has a thickness comprised between a few nanometres and a few tens of nanometres. This characteristic makes it possible to protect the support face 101 of the external part 10 from chemical and environmental aggressions, such as humidity, and to colour it by a precisely chosen interference effect in a repeatable and robust way. The thickness of the thin-film dielectric coating 110 is therefore homogeneous and consistent across its entire surface.

The support face 101 can have structuring, for example by mechanical machining, for example by manual engraving or machining with a numerically controlled machine tool, by chemical machining or by laser machining. The structuring is formed by hollows and peaks, the distance between the hollows and peaks being, for example, at least 1 μm.

The thin-film dielectric coatings 110 are formed by at least one alternation of layers made of TiO₂ and Al₂O₃ and comprises a terminal layer 111 made of TiO₂ and a base layer 112 overlying the support face 101 made of TiO₂ or of Al₂O₃.

It is be understood in this case that the nature of the base layer 112 depends on the number of thin-film dielectric coatings 110, and in particular on whether the number of thin-film dielectric coatings is even or odd.

The interference colour obtained by the combination of the thin-film dielectric coatings 110 and the support face 101 depends in particular on the thickness of each thin-film dielectric coating 110, on their arrangement and their number, and the material of which the support face 101 is made.

In particular, the present invention proposes a specific arrangement of the thin-film dielectric coatings 110 associated with a support face 101 made of chromium carbide, in which the stoichiometric ratios are chosen so that the complex refractive index at a wavelength of 550 nm has a real part n>1 and an imaginary part k<1.5.

Advantageously, due to the choice of the nature and thickness of the layers in the thin-film dielectric coatings 110 and the material of the support face 101, and in particular the stoichiometric ratio between the carbon and the chromium of the support face 101, the interference colour generated by the characteristics of the invention is very precise and can be chosen from a wide range of colours.

In particular, in a first exemplary embodiment of the present invention shown in FIG. 1, the support face 101 has an equal atomic proportion of carbon and of chromium. The intrinsic colour is then grey with a yellow tone, which, in combination with the thin-film dielectric coating 110, makes it possible to achieve a range of colours that would be difficult to obtain other than with the characteristics of the invention.

In a first variant of this exemplary embodiment of the invention, the thin-film dielectric coating 110 comprises six layers, the base layer 112 being made of Al₂O₃. The layers in the thin-film dielectric coatings 110 have thicknesses chosen so as to impart an interference colour to the external part 10 characterised, in the CIELAB space in the reflection mode of the standardised illuminant D65, with an observer of 10° and a measurement geometry di:8°, by the parameters L*=[15; 25], a*=[35; 45], b*=[15; 25], and more specifically by the parameters L*=22, a*=39, b*=19.

Thus, in this first variant, the external part 10 has a colour comprised in shades of red, for example a burgundy or an orange red.

In a second variant of this exemplary embodiment of the invention, as shown in FIG. 2, the thin-film dielectric coatings 110 comprise five layers, the base layer 112 being made of TiO₂. The layers in the thin-film dielectric coating 110 have thicknesses chosen so as to impart an interference colour to the external part 10 characterised, in the CIELAB space in the reflection mode of the standardised illuminant D 65, with an observer of 10° and a measurement geometry di:8°, by the parameters L*=[45; 55], a*=[−10; 0], b*=[0; 10], and more specifically by the parameters L*=50, a*=−7, b*=7.

Thus, in this second variant, the external part 10 has a dark green appearance.

In this exemplary embodiment of the invention, each layer in the thin-film dielectric coatings 110 can have a thickness comprised between one or a few nanometres, for example between 1 nm and 10 nm, and a few tens of nanometres, for example between 80 nm and 90 nm.

In a second exemplary embodiment of the invention, the support face 101 has a lower atomic proportion of chromium than of carbon.

In a first variant of this exemplary embodiment, which can be seen in FIG. 3, the support face 101 can have an atomic percentage of carbon greater than 60%. The intrinsic colour is then comprised in a shade of dark grey with a more neutral tone than in the first example, which, in combination with the thin-film dielectric coating 110, makes it possible to achieve a range of colours that would be difficult to obtain other than with the characteristics of the invention.

In this variant, the thin-film dielectric coating 110 can comprise three layers, the base layer 112 being made of TiO₂. The layers in the thin-film dielectric coatings 110 have thicknesses chosen so as to impart an interference colour to the external part 10 characterised, in the CIELAB space in the reflection mode of the standardised illuminant D65, with an observer of 10° and a measurement geometry di:8°, by the parameters L*=[70; 80], a*=[−10; 0], b*=[−5; 5], and more specifically by the parameters L*=76, a*=−6, b*=−1.

Thus, in this first variant, the external part 10 has a light green appearance.

In a second variant shown in FIG. 4, the support face 101 can have an atomic percentage of carbon greater than 80%. The intrinsic colour is then comprised in a shade of very dark grey or even black, which, in combination with the thin-film dielectric coating 110, makes it possible to achieve a range of colours that would be difficult to obtain other than with the characteristics of the invention.

In this variant, the thin-film dielectric coatings 110 comprise four layers, the base layer 112 being made of Al₂O₃. The layers in the thin-film dielectric coatings 110 have thicknesses chosen so as to impart an interference colour to the external part 10 characterised, in the CIELAB space in the reflection mode of the standardised illuminant D65, with an observer of 10° and a measurement geometry of di:8°, by the parameters L*=[35; 45], a*=[−5; 5], b*=[−10; −20], and more specifically by the parameters L*=40, a*=−3, b*=−15.

Thus, in this variant, the external part 10 has a blue appearance.

In this second exemplary embodiment of the invention, each layer in the thin-film dielectric coatings 110 can have a thickness comprised between one or a few nanometres, for example between 5 nm and 10 nm, and a few tens of nanometres, for example between 70 nm and 80 nm.

More generally, it should be noted that the embodiments and uses considered above have been described by way of non-limiting examples, and that other variants are therefore conceivable.

1. An external part for horology, jewellery or fine jewellery, comprising a substrate having a support face made of chromium carbide CrₓC_{y} in which the complex refractive index at a wavelength of 550 nm has a real part n>1 and an imaginary part k<1.5, on which is deposited a semi-transparent thin-film dielectric coating formed by at least one alternation of layers made of TiO₂ and Al₂O₃ and comprising a terminal layer made of TiO₂ and a base layer made of TiO₂ or of Al₂O₃ overlying the support face.

2. The external part according to claim 1, wherein the support face is a face of a support layer made of CrₓC_{y} on a substrate body.

3. The external part according to claim 1, wherein the support face has an equal atomic proportion of carbon and of chromium.

4. The external part according to claim 3, wherein the thin-film dielectric coating comprises five layers, the base layer being made of TiO₂, the layers in the thin-film dielectric coatings having thicknesses chosen so as to impart an interference colour to the external part characterised, in the CIELAB space in the reflection mode of the standard illuminant D65, with an observer of 10° and a measurement geometry di:8°, by the parameters L*=[45; 55], a*=[−10; 0], b*=[0; 10].

5. The external part according to claim 3, wherein the thin-film dielectric coating comprises six layers, the base layer being made of Al₂O₃, the layers in the thin-film dielectric coatings having thicknesses chosen so as to impart an interference colour to the external part characterised, in the CIELAB space in the reflection mode of the standard illuminant D65, with an observer of 10° and a measurement geometry di:8°, by the parameters L*=[15; 25], a*=[35; 45], b*=[15; 25].

6. The external part according to claim 1, wherein the support face has a lower atomic proportion of chromium than of carbon.

7. The external part according to claim 6, wherein the support face has an atomic percentage of carbon greater than 60%.

8. The external part according to claim 7, wherein the thin-film dielectric coating comprises three layers, the base layer being made of TiO₂ the layers in the thin-film dielectric coatings having thicknesses chosen so as to impart an interference colour to the external part characterised, in the CIELAB space in the reflection mode of the standard illuminant D65, with an observer of 10° and a measurement geometry di:8°, by the parameters L*=[70; 80], a*=[−10; 0], b*=[−5; 5].

9. The external part according to claim 6, wherein the support face has an atomic percentage of carbon greater than 80%.

10. The external part according to claim 8, wherein the thin-film dielectric coating comprises six layers, the base layer being made of Al₂O₃, the layers in the thin-film dielectric coatings having thicknesses chosen so as to impart an interference colour to the external part characterised, in the CIELAB space in the reflection mode of the standard illuminant D65, with an observer of 10° and a measurement geometry di:8°, by the parameters L*=[35; 45], a*=[−5; 5], b*=[−10; −20].
